(19) United States
(12) Patent Application Publication
(10) Pub. No.: US 2025/0194886 A1
(43) Pub. Date: Jun. 19, 2025

(54) CLEANING DEVICE

(71) Applicant: J.Wagner GmbH, Markdorf (DE)

(72) Inventors: Stephan HETZINGER, Schorndorf (DE); Hans-Jorg HOPFENGART, Aichwald (DE); Thomas POST, Hockdorf (DE); Antonio DE FILIPPO, Backnang (DE)

(21) Appl. No.: 18/848,240

(22) PCT Filed: Mar. 20, 2023
(86) PCT No.: PCT/EP2023/057063

§ 371 Date: Sep. 18, 2024

(30) Foreign Application Priority Data
Mar. 31, 2022 (DE) 10 2022 107 727.6

(51) Int. Cl. A47L 11/40; H01F 7/02

(52) U.S. Cl. CPC A47L 11/4016; A47L 11/4041; H01F 7/0252

(57) ABSTRACT

A cleaning appliance includes a housing, a tank, at least one cleaning roller, and a retaining mechanism. The housing includes a receiving space open in a downward direction, and each cleaning roller is mounted in the housing and rotatable about a longitudinal axis. The retaining mechanism includes a first constituent part in the form of a first number of at least one retaining element fixed on the tank, a second constituent part in the form of a second number of mating retaining elements, and a third constituent part in the form of a slide guided on the housing. In a retaining position of the slide, the mating retaining elements and the at least one retaining element are aligned with one another in pairs. A magnetic interaction forms a third number of magnetic closures. The third number corresponding to the first number. The tank is retained purely magnetically on the housing.

### CROSS-REFERENCES TO RELATED APPLICATIONS

This Application is a Section 371 National Stage Application of International Application No. PCT/EP2023/057063, filed Mar. 20, 2023, and published as WO 2023/186604 A1 on Oct. 5, 2023, and claims priority to German Application No. 102022107727.6, filed Mar. 31, 2022; the contents of these applications are hereby incorporated by reference in their entirety.

### BRIEF DESCRIPTION OF THE DRAWINGS

FIG. 1 shows a sectional side view of constituent parts of one example of a cleaning appliance, wherein a slide is in a release position.

FIG. 2 shows the side view shown in FIG. 1 with the slide in the retaining position.

FIG. 3 shows a perspective view of the tank from FIGS. 1 and 2.

FIG. 4 shows a perspective plan view of the cleaning appliance shown in FIGS. 1 to 3.

FIG. 5 shows an underside view of the slide shown in FIGS. 1 to 4.

### DETAILED DESCRIPTION

The present disclosure relates to a cleaning appliance for surfaces according to the preamble of claim 1.

Patent document AT 406 633 B discloses a cleaning appliance which comprises a housing, a tank, at least one cleaning roller and a retaining mechanism, wherein the housing comprises a receiving space, which is open in the downward direction, and wherein each cleaning roller is mounted in the housing such that it can be rotated about a longitudinal axis.

DE 60 2005 002 740 T2 discloses a surface-cleaning apparatus having a debris-retrieval body and at least one collecting device, which is provided within the debris-retrieval body in order to collect debris from a surface which is to be cleaned. A rotatable elongate brush arrangement is likewise provided within the debris-retrieval body, in order to retrieve a first amount of the debris from the surface which is to be cleaned and to direct the first amount of the debris along a first pathway into the at least one collecting means.

DE 11 2010 005 975 T2 discloses an easy-to-dismantle sweeping machine containing a sweeping device, a machine body and a dust container, which is connected to the machine body, and wherein the sweeping machine also contains a magnetic device for the purpose of putting together or separating the dust container and the machine body.

The present disclosure is based on an object of proposing a cleaning appliance, or surface-cleaning appliance, for which handling of the tank is more straightforward.

Proceeding from the features of the preamble of claim 1, this object is achieved by the characterizing features of claim 1. Advantageous and expedient developments are specified in the dependent claims.

In the case of the cleaning appliance according to one example of the present disclosure, which comprises a housing, a tank, at least one cleaning roller and a retaining mechanism, wherein the housing comprises a receiving space, which is open in the downward direction, and wherein each cleaning roller is mounted in the housing such that it can be rotated about a longitudinal axis, the retaining mechanism comprises a first constituent part in the form of a first number of at least two retaining elements, which are fixed on the tank, the retaining mechanism comprises a second constituent part in the form of a second number of mating retaining elements, the second number corresponding to the first number, wherein the retaining mechanism comprises a third constituent part in the form of a slide guided on the housing, wherein the mating retaining elements are fixed on the slide and wherein, in a retaining position of the slide, the mating retaining elements and the retaining elements are aligned with one another in pairs, and wherein the magnetic interaction thereof forms a third number of magnetic closures, the third number corresponding to the first number, so that the tank is retained purely magnetically on the housing. As a result, in the retaining position of the slide, the tank can easily be fitted onto the housing without any guides and/or a latching-in action having to be taken into consideration.

Provision is also made so that, in the retaining position of the slide, the tank is retained on the housing such that it is retained on the housing in a manner suspended above an underlying surface which is to be cleaned and on which the cleaning appliance rests by way of the at least one cleaning roller. This ensures that it is even possible for the tank to be forcibly removed or pressed downward and the tank maintains its positioning so that tank contents remain in the tank.

Provision is also made so that, in a release position of the slide, the mating retaining elements are offset in relation to the retaining elements such that the active magnetic forces are not sufficient to retain the tank on the housing. This means that, in the release position of the slide, detachment of the tank takes place automatically.

Provision is further made for the slide to have fixed on it, adjacent to each mating retaining element, an additional element which, in a/the release position, is aligned with the retaining element assigned to the respective magnetic closure, wherein each additional element is formed by a permanent magnet which is arranged such that it repels the retaining element likewise designed in the form of a permanent magnet. This means that the tank can be actively dismounted; therefore, separation of the tank from the housing is ensured even when the tank adheres to the housing as a result of soiling.

Provision is also made for the retaining mechanism to be equipped with at least three magnetic closures, wherein the magnetic closures of the retaining mechanism form corner points of a polygon and in particular of a triangle or of a quadrilateral and preferably of a rectangle or of a square. On the one hand, this ensures that the tank is retained securely on the housing. On the other hand, it is also possible for the above-described dismounting operation—if realized—to be realized in a highly reliable manner, since the arrangement of magnetic closures prevents skewing.

It is also the case that the retaining mechanism comprises a fourth constituent part in the form of a mechanism mounted on the housing, wherein the slide can be displaced by means of this mechanism between the retaining position and the release position. This means that the movement of the slide can be controlled remotely, so that the slide can be installed in a concealed state in the housing.

Provision is also made for the mechanism to be equipped with a camshaft, which is mounted in a pivotable manner on the housing, and for the slide to be formed with a receiving pocket, in which a cam of the camshaft engages such that the slide is in the retaining position following left-hand rotation of the cam and that the slide is in the release position following right-hand rotation of the cam, wherein the slide moves in particular transversely in relation to a longitudinal axis of the at least one cleaning roller. This allows the remote control of the slide to be realized in a mechanically straightforward manner. A rocker switch is provided for the purpose of actuating the camshaft, the actuation of the rocker switch allowing the shaft to be rotated to the right and to the left.

Provision is further made for the retaining mechanism to be equipped with a fifth constituent part, wherein the fifth constituent part comprises at least one arresting element, which is respectively arranged in a fixed state on the housing and, in the retaining position or the release position, interacts magnetically with one of the mating retaining elements mounted on the slide, or with one of the additional elements mounted on the slide, such that, in the retaining position or in the release position, the slide is retained magnetically on the housing. It can thus be ensured that the slide remains in the selected position. In particular, it is thereby possible to prevent undesired changeover of the slide from the release position into the retaining position and vice versa. Of course, it is also possible for the release position and the retaining position to be secured by two differently arranged arresting elements.

Provision is also made
so that the retaining elements are designed in the form of permanent magnets and the mating retaining elements are designed in the form of elements which can be magnetically attracted, or
so that the mating retaining elements are designed in the form of permanent magnets and the retaining elements are designed in the form of elements which can be magnetically attracted, or
so that the retaining elements are designed in the form of permanent magnets and the mating retaining elements are designed in the form of permanent magnets, or
so that the retaining elements and the mating retaining elements and the additional elements are designed in the form of permanent magnets, or
so that the retaining elements and the additional elements are designed in the form of permanent magnets and so that the mating retaining elements are designed in the form of elements which can be magnetically attracted, or
so that the arresting element interacts with a mating retaining element designed in the form of a permanent magnet or with an additional element designed in the form of a permanent magnet and it is itself designed in the form of an element which can be magnetically attracted or in the form of a permanent magnet, or
so that the arresting element interacts with a mating retaining element designed in the form of an element which can be magnetically attracted and it is itself designed in the form of a permanent magnet.

This allows the cost of the cleaning appliance to be adjusted in dependence on the range of functions thereof, since more or fewer permanent magnets have to be used in each case.

Finally, provision is made for the cleaning appliance to be designed in the form of a wet-cleaning appliance and the tank to be designed in the form of a dirty-water tank. An automatic detachment function is particularly advantageous for dirty-water tanks since it is thereby possible to avoid spillage from the dirty-water tank in the event of the latter being separated from the housing with a jerking motion.

Within the context of the present disclosure, a slide is understood to mean both a linear slide and a rotary slide.

Further details of the present disclosure are described in the drawing with reference to a schematically illustrated exemplary embodiment.

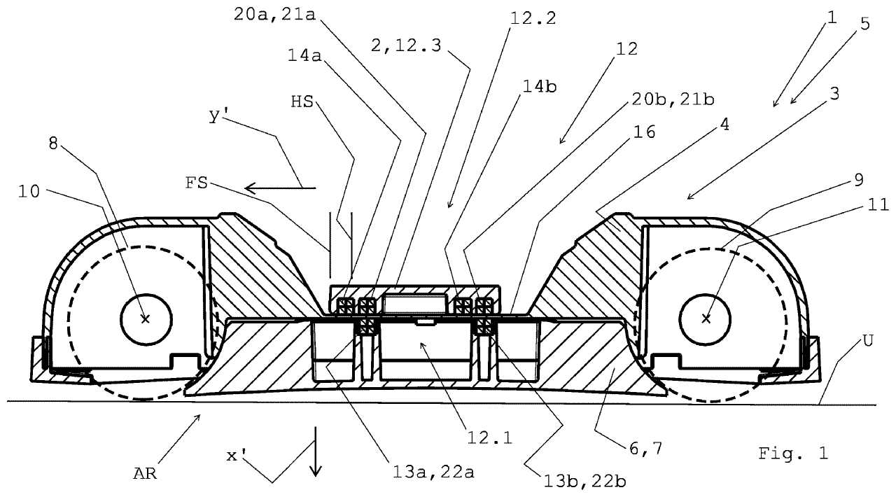

FIGS. 1 to 5 show relevant constituent parts of the cleaning appliance 1 according to one example. FIG. 1 shows a sectional side view of constituent parts of the cleaning appliance 1, wherein a slide 2 is in a release position FS.

The cleaning appliance 1 comprises a housing 3, of which only an inner shell 4 is shown. An outer shell (not illustrated), which completes the housing 3, covers over the inner shell 4, so that the slide 2 is received between the inner shell 4 and the outer shell (not illustrated). The cleaning appliance 1 also comprises a handle (not illustrated), which is connected in an articulated manner to the housing 3.

The cleaning appliance 1, which is designed in the form of a wet-cleaning appliance 5, further comprises a tank 6, which is designed in the form of a dirty-water tank 7.

The cleaning appliance 1 also comprises a first, front cleaning roller 8 and a second, rear cleaning roller 9, wherein these are illustrated purely schematically and are mounted on the housing 3 such that they can be rotated about a front longitudinal axis 10 and a rear longitudinal axis 11. The cleaning appliance further comprises a retaining mechanism 12.

The housing 3 has a receiving space AR, which is open in the downward direction and in which the tank 6 is received and the cleaning rollers 8, 9 are mounted such that they can be rotated about their longitudinal axes 10, 11.

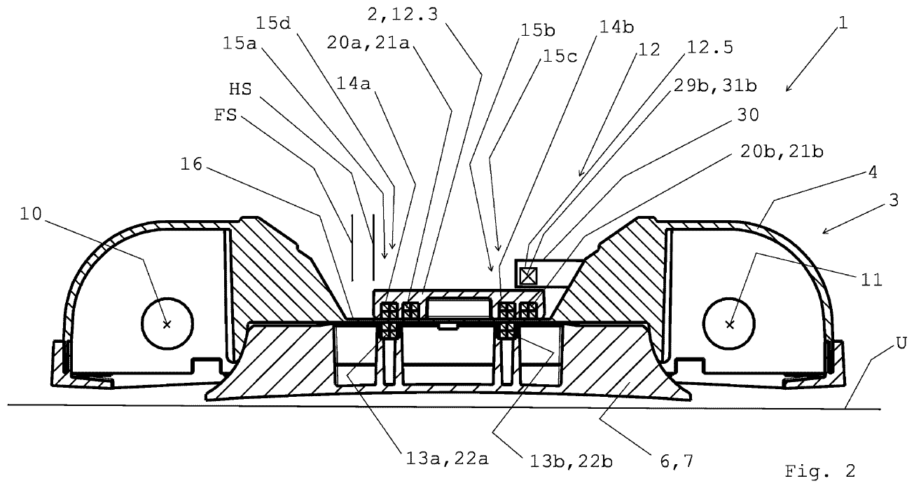

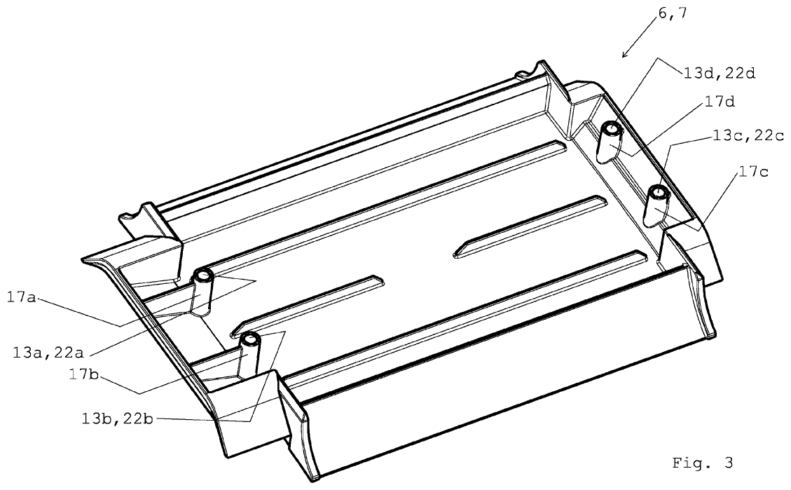

The retaining mechanism 12 comprises a first constituent part 12.1 in the form of four retaining elements 13a, 13b, 13c, 13d, which are fixed on the tank 6 (see also FIGS. 2 and 3).

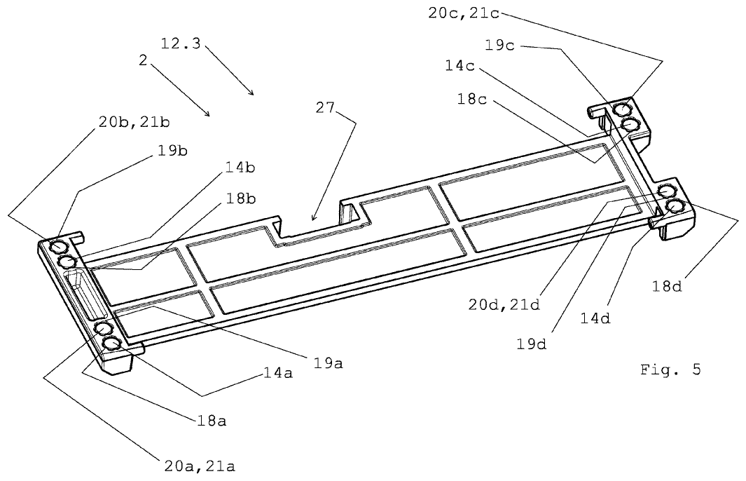

The retaining mechanism 12 comprises a second constituent part 12.2 in the form of four mating retaining elements 14a, 14b, 14c, 14d and the retaining mechanism 12 comprises a third constituent part 12.3 in the form of the slide 2, wherein the mating retaining elements 14a, 14b, 14c, 14d are fixed on the slide 2 (see FIGS. 1, 2 and 5). The slide 2 is illustrated in FIG. 5 here in a perspective view from beneath.

In a manner analogous to FIG. 1, but without the cleaning rollers being illustrated, FIG. 2 shows, once again, a sectional side view of constituent parts of the cleaning appliance 1, wherein in this case the slide 2 is in a retaining position HS. In the retaining position HS of the slide 2, the mating retaining elements 14a to 14d and the retaining elements 13a to 13d are aligned with one another in pairs and, by way of magnetic interaction, form four magnetic closures 15a, 15b, 15c, 15d, wherein the magnetic closures 15c and 15d are concealed in FIG. 2 by the magnetic closures 15a and 15b. Accordingly, in the retaining position HS of the slide 2, the tank 6 is retained purely magnetically on the housing 3 above an underlying surface U (see FIG. 2), on which the cleaning appliance rests by way of its cleaning rollers 8, 9 (see FIG. 1).

In the release position FS of the slide 2, this position being shown in FIG. 1, the mating retaining elements 14a to 14d are offset in relation to the retaining elements 13a to 13d such that the magnetic forces acting therebetween are not sufficient to retain the tank 6 on the housing 3, and so, at the moment when the slide 2 is displaced all the way to the left in arrow direction y′ out of the retaining position HS (FIG. 2) into the release position FS (FIG. 1), the tank drops downward in arrow direction x′ onto the underlying surface U. In FIG. 1, the tank 6 is in the process of detaching from the housing 3.

It can also be seen from FIG. 2 that the magnetic forces acting between the retaining elements 13a to 13d and the mating retaining elements 14a to 14d act through a wall 16 of the inner shell 4. In this case, the slide 2 rests on the wall 16 from above by way of the mating retaining elements 14a to 14d and the tank 6 butts against the wall 16 from beneath by way of the retaining elements 13a to 13d.

As can be seen from the perspective illustration of the tank 6 in FIG. 3, the retaining elements 13a to 13d are adhesively bonded into hollow-cylindrical bosses 17a to 17d formed on the tank 6.

Likewise—as can be seen from the perspective underside view of the slide 2 in FIG. 5—the mating retaining elements 14a to 14d are adhesively bonded into depressions 18a to 18d, which are formed in the slide 2.

In FIG. 5, and also in FIGS. 1 and 2, it is also possible to see on the slide 2, adjacent to each mating retaining element 14a to 14d, additional elements 20a to 20d fixed in further depressions 19a to 19d. In the release position FS—as is shown in FIG. 1—the additional elements 20a to 20d—in a manner comparable to the mating retaining elements 14a to 14d in FIG. 2—are aligned with the retaining elements 13a to 13d. Each additional element 20a to 20d here is formed by a permanent magnet 21a to 21d and is installed in the slide 2 such that each additional element respectively repels the retaining elements 13a to 13d, which are likewise designed in the form of permanent magnets 22a to 22d. This means that, in the release position FS of the slide 2, the tank 6 is actively repelled downward from the housing 2, in the arrow direction x′, by magnetic forces.

As already mentioned, the retaining mechanism 12 comprises four magnetic closures 15a to 15d, wherein, as seen in plan view, these magnetic closures form corner points of a rectangle.

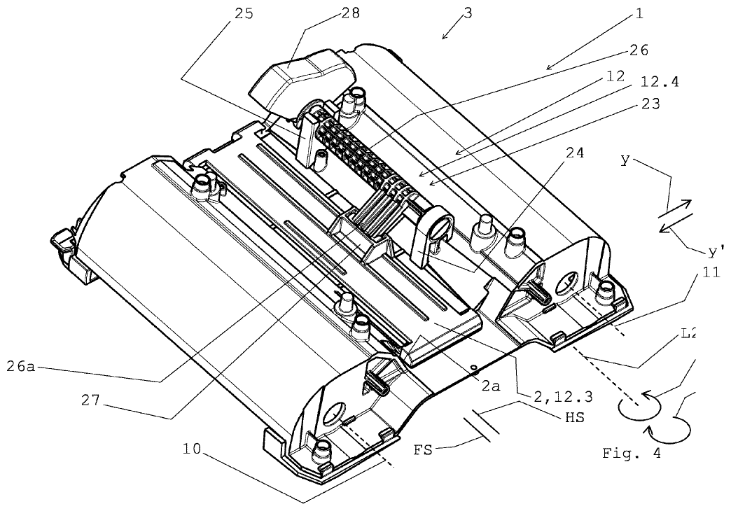

Optionally, the retaining mechanism 12 comprises a fourth constituent part 12.4 in the form of a mechanism 23 (see FIG. 4) mounted on the housing 3. The slide 2 here can be displaced by means of this mechanism 23 between the retaining position HS (FIG. 2) and the release position FS (FIG. 1), wherein in FIG. 4 the slide 2 is in the release position FS. The retaining position HS is likewise indicated in FIG. 4. In order to reach the retaining position, the slide 2 is moved rearward in arrow direction y, so that a front edge 2a of the slide 2 is then level with the marking HS, rather than with the marking FS. As can be seen from FIG. 4, the mechanism 23 comprises a camshaft 26, which is mounted in a pivotable manner on bearing blocks 24, 25 of the housing 3. The slide 2 comprises a receiving pocket 27 (see also FIG. 5), in which a cam 26a of the camshaft 26 engages. Left-hand rotation of the cam 26a about a longitudinal axis L26 of the camshaft 26 in a direction of rotation L causes the slide 2 to move in the arrow direction y out of the release position FS (illustrated) into the retaining position HS. Right-hand rotation of the cam 26a about the longitudinal axis L26 of the camshaft 26 in the direction of rotation R causes the slide 2 to move in the arrow direction y′ out of the retaining position HS into the release position FS, which is illustrated in FIG. 4. The slide 2 here is moved transversely in relation to the longitudinal axes 10, 11 of the cleaning rollers 8, 9.

The mechanism 23 also comprises a rocker lever 28, which is connected for conjoint rotation to the camshaft 26 and which can bring about the above-described rotation of the cam 26a.

Optionally—and illustrated exclusively in FIG. 2—the retaining mechanism 12 comprises a fifth constituent part 12.5 in the form of an arresting element 29b, which is arranged in a fixed state on the housing 3, in a mount 30, and, in the retaining position HS (FIG. 2), interacts magnetically with the additional element 20b mounted on the slide 2. In that the retaining position HS (FIG. 2), the arresting element 29b designed in the form of a permanent magnet 31b, which attracts the additional element 20b, causes the slide 2 to be retained magnetically on the housing 3. This effectively prevents any undesired movement of the slide 2 out of the retaining position HS (FIG. 2) into the release position FS (FIG. 1), which could be triggered for example by an underlying surface which generates disadvantageous vibrations. Alternatively, in the case of a different design, the arresting element 29b can also interact with the mating retaining element 14b. In the same way as the arresting element 29b, is also possible for up to three further arresting elements to be provided, which then each interact with one of the mating retaining elements or one of the further additional elements.

Depending on whether the variant selected is one which has only a retaining element and mating retaining element or, in addition, an additional element or also an arresting element, the aforementioned components can be designed—due consideration being given in the process to the desired function—in the form of permanent magnets or of components which become magnetized in the vicinity of a magnetic field, wherein, as far as the permanent magnets are concerned, consideration additionally has to be given to alignment which ensures the desired function-attracting action, repelling action.

Although the present invention has been described with reference to preferred embodiments, workers skilled in the art will recognize that changes may be made in form and detail without departing from the spirit and scope of the invention.

### LIST OF REFERENCE SIGNS

1 cleaning appliance
2 slide
2a front edge of 2
3 housing
4 inner shell
not illustrated outer shell
5 wet-cleaning appliance
6 tank
7 dirty-water tank
8 first, front cleaning roller
9 second, rear cleaning roller
10 front longitudinal axis
11 rear longitudinal axis
12 retaining mechanism
12.1 first constituent part of 12
12.2 second constituent part of 12
12.3 third constituent part of 12
12.4 fourth constituent part of 12
12.5 fifth constituent part of 12
13a-13d retaining element on 6
14a-14d mating retaining element on 2
15a-15d magnetic closure
16 wall of 4
17a-17d boss of 6
18a-18d depression in 2 for 14a-14d
19a-19d depression in 2 for 20a-20d
20a-20d additional element
21a-21d permanent magnet forming 20a-20d
22a-22d permanent magnet forming 13a-13d
23 mechanism forming 12.4
24,25 bearing block of 3
26 camshaft
26a cam of 26
27 receiving pocket on 2
28 rocker lever
29b arresting element on 3
30 mount for 29b
31b permanent magnet forming 29b
AR receiving space
FS release position of 2
L left-hand rotation of 26a about L26
L26 longitudinal axis of 26
HS retaining position of 2
R right-hand rotation of 26a about L26
U underlying surface
x′ downward arrow direction
y arrow direction to the right or rear
y′ arrow direction to the left or front

1. A cleaning appliance comprising a housing, a tank, at least one cleaning roller and a retaining mechanism,
wherein the housing comprises a receiving space, which is open in a downward direction,
wherein each cleaning roller, of the at least one cleaning roller, is mounted in the housing is rotatable about a longitudinal axis,
wherein the retaining mechanism comprises a first constituent part in the form of a first number of at least one retaining element fixed on the tank,
wherein the retaining mechanism comprises a second constituent part in the form of a second number of mating retaining elements,
wherein the retaining mechanism comprises a third constituent part in the form of a slide guided on the housing, wherein the mating retaining elements are fixed on the slide,
wherein, in a retaining position of the slide, the mating retaining elements and the at least one retaining element are aligned with one another in pairs, wherein a magnetic interaction thereof forms a third number of magnetic closures, the third number corresponding to the first number, so that the tank is retained purely magnetically on the housing.

2. The cleaning appliance as claimed in claim 1, wherein, in the retaining position of the slide, the tank is retained on the housing such that the tank is retained on the housing in a manner suspended above an underlying surface which is to be cleaned and on which the cleaning appliance rests by way of the at least one cleaning roller.

3. The cleaning appliance as claimed in claim 1, wherein, in a release position of the slide, the mating retaining elements are offset in relation to the retaining elements such that the active magnetic forces are not sufficient to retain the tank on the housing.

4. The cleaning appliance as claimed in claim 3, wherein an additional element is fixed on the slide adjacent to each mating retaining element, wherein the additional element, in the release position, is aligned with the retaining element assigned to the respective magnetic closure, wherein the additional element is formed by a permanent magnet which is arranged such that the permanent magnet repels the retaining element designed in the form of a permanent magnet.

5. The cleaning appliance as claimed in claim 1, wherein the retaining mechanism comprises at least three magnetic closures, wherein, in plan view, the magnetic closures of the retaining mechanism form corner points of a polygon.

6. The cleaning appliance as claimed in claim 3, wherein the retaining mechanism comprises a fourth constituent part in the form of a mechanism mounted on the housing, wherein the slide can be displaced by means of the mechanism between the retaining position and a release position.

7. The cleaning appliance as claimed in claim 6, wherein
the mechanism comprises a camshaft, which is mounted in a pivotable manner on the housing,
the slide comprises a receiving pocket,
a cam of the camshaft engages such that the slide is in the retaining position following left-hand rotation of the cam and
the slide is in the release position following right-hand rotation of the cam, and
the slide moves in particular transversely in relation to a longitudinal axis of the at least one cleaning roller.

8. The cleaning appliance as claimed in claim 4, wherein
the retaining mechanism comprises a fifth constituent part, wherein the fifth constituent part comprises at least one arresting element, which is respectively arranged in a fixed state on the housing, and,
the retaining position and/or the release position interacts magnetically with one of the mating retaining elements mounted on the slide, or with the additional element mounted on the slide, such that, in the retaining position or in the release position, the slide is retained magnetically on the housing.

9. The cleaning appliance as claimed in claim 8, wherein
the retaining elements are designed in the form of permanent magnets and the mating retaining elements are designed in the form of elements which can be magnetically attracted, or
the mating retaining elements are designed in the form of permanent magnets and the retaining elements are designed in the form of elements which can be magnetically attracted, or
the retaining elements are designed in the form of permanent magnets and the mating retaining elements are designed in the form of permanent magnets, or
the retaining elements and the mating retaining elements and the additional element are designed in the form of permanent magnets, or
the retaining elements and the additional element are designed in the form of permanent magnets and the mating retaining elements are designed in the form of elements which can be magnetically attracted, or
the at least one arresting element interacts with a mating retaining element designed in the form of a permanent magnet or with an additional element designed in the form of a permanent magnet and it is itself designed in the form of an element which can be magnetically attracted or in the form of a permanent magnet, or
the arresting element interacts with a mating retaining element designed in the form of an element which can be magnetically attracted and it is itself designed in the form of a permanent magnet.

10. The cleaning appliance as claimed in claim 1, wherein the cleaning appliance is designed in the form of a wet-cleaning appliance and the tank is designed in the form of a dirty-water tank.

11. The cleaning appliance as claimed in claim 1, wherein the second number of mating retaining elements corresponds to the first number of retaining elements.

12. The cleaning appliance as claimed in claim 1, wherein the at least one retaining element comprises at least two retaining elements.

13. The cleaning appliance as claimed in claim 5, wherein the magnetic closures of the retaining mechanism form corner points of a triangle.

14. The cleaning appliance as claimed in claim 5, wherein the magnetic closures of the retaining mechanism form corner points of a quadrilateral.

15. The cleaning appliance as claimed in claim 5, wherein the magnetic closures of the retaining mechanism form corner points of a rectangle.

16. The cleaning appliance as claimed in claim 5, wherein the magnetic closures of the retaining mechanism form corner points of a square.
